(19) United States
(12) Patent Application Publication
(10) Pub. No.: US 2004/0217848 A1
(43) Pub. Date: Nov. 4, 2004

(54) Audio alarm system for vehicle use

(75) Inventor: Wen-Pin Cheng, Chung-Ho City (TW)

Correspondence Address: WEBB ZIESENHEIM LOGSDON, ORKIN & HANSON P.C., 700 Koppers Building, 436 Seventh Avenue, Pittsburgh, PA, 15219-1818, US

(73) Assignee: WINTECRONICS CO., LTD.

(21) Appl. No.: 10/427,667

(22) Filed: May 1, 2003

(51) Int. Cl. B60Q 1/00

(52) U.S. Cl. 340/425.5

(57) ABSTRACT

An audio alarm system is adapted to be installed in a vehicle, which has a set of sensors disposed thereon. Each of the sensors detects the presence of an associated event. The audio alarm system includes a control unit configured to generate a set of control signals, each of which is generated in response to detection of the presence of the associated event by a corresponding one of the sensors. An audio processing unit has a set of alarm sound data stored therein. The alarm sound data are distinguishable from each other and correspond respectively to the control signals. In response to the control signal received from the control unit, the audio processing unit selects the corresponding one of the alarm sound data. A loudspeaker generates an audible alarm output corresponding to the alarm sound data selected by the audio processing unit.

### BACKGROUND OF THE INVENTION

1. Field of the Invention

The invention relates to an alarm system for vehicles, more particularly to an audio alarm system for vehicle use.

2. Description of the Related Art

Vehicle alarm systems are installed to protect vehicles from prospective thieves and vandals. A conventional vehicle alarm system generally includes a main terminal and a remote controller. The main terminal is installed in the vehicle, and includes a processor connected to a set of sensors. The sensors can include pressure sensors, vibration sensors, infrared sensors, etc., which are disposed on different locations of the vehicle, such as a door handle or the vehicle trunk.

The remote controller is operated by the vehicle owner to control operation of the main terminal. For example, when the main terminal is armed through the remote controller, and an event is detected by one of the sensors, such as operation of a door handle, impact to the vehicle body, etc., the processor will activate a loudspeaker on the vehicle body so as to generate an audible alarm output to attract the attention of people nearby, thereby discouraging prospective thieves and vandals.

In the conventional vehicle alarm system, the audible alarm output is generally a single alarm signal that is repeatedly reproduced within a time period. Therefore, in a large parking area filled with vehicles, it is difficult to determine which vehicle generated the alarm output. In addition, since the same alarm output is generated regardless of the event detected by the corresponding sensor, people are not informed of the actual condition of the vehicle that generated the alarm output.

### SUMMARY OF THE INVENTION

Therefore, the object of the present invention is to provide a vehicle audio alarm system that is capable of overcoming the aforesaid drawbacks of the prior art.

According to one aspect of the invention, an audio alarm system is adapted to be installed in a vehicle, which has a set of sensors disposed thereon. Each of the sensors detects the presence of an associated event. The audio alarm system comprises:

a control unit adapted to be connected electrically to the sensors and configured to generate a set of control signals, each of the control signals being generated by the control unit in response to detection of the presence of the associated event by a corresponding one of the sensors;

an audio processing unit having a set of alarm sound data stored therein, the alarm sound data being distinguishable from each other and corresponding respectively to the control signals, the audio processing unit being connected electrically to the control unit and, in response to the control signal received from the control unit, selecting the corresponding one of the alarm sound data; and

a loudspeaker connected electrically to the audio processing unit and operable so as to generate an audible alarm output corresponding to the alarm sound data selected by the audio processing unit.

According to another aspect of the invention, there is provided an audio alarm system for a vehicle having a set of sensors disposed thereon. Each of the sensors detects the presence of an associated event. The audio alarm system comprises a main terminal and a remote controller. The main terminal is adapted to be installed in the vehicle, and generates an audible alarm output in response to detection of the presence of the event associated with any one of the sensors when the main terminal is armed. The remote controller is operably associated with the main terminal to control arming and disarming of the main terminal. The main terminal includes a control unit, an audio processing unit, and a loudspeaker. The control unit is adapted to be connected electrically to the sensors, and is configured to generate a set of control signals. Each of the control signals is generated by the control unit in response to detection of the presence of the associated event by a corresponding one of the sensors. The audio processing unit has a set of alarm sound data stored therein. The alarm sound data are distinguishable from each other and correspond respectively to the control signals. The audio processing unit is connected electrically to the control unit and, in response to the control signal received from the control unit, selects the corresponding one of the alarm sound data. The loudspeaker is connected electrically to the audio processing unit and is operable so as to generate the audible alarm output that corresponds to the alarm sound data selected by the audio processing unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of an audio alarm system according to the present invention; and

FIG. 2 illustrates a set of exemplary alarm sound data resident in a data storage unit of the preferred embodiment.

### DETAILED DESCRIPTION OF THE PREFERRED EMBODIMENT

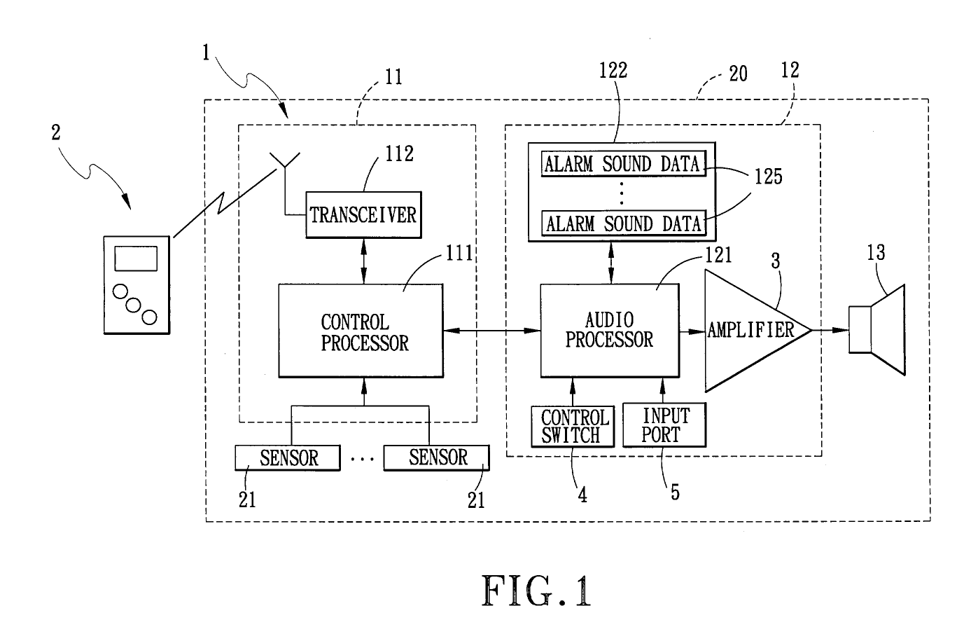

Referring to FIG. 1, the preferred embodiment of an audio alarm system according to the present invention is shown to include a main terminal 1 that is adapted to be installed in a vehicle 20, such as near an instrument panel of the vehicle 20, and a remote controller 2. The main terminal 1 is connected electrically to a set of sensors 21, and operates according to events detected by the sensors 21 when armed. The sensors 21 are disposed on different locations of the vehicle 20, such as a door handle, the vehicle trunk, the engine hood, etc., and detect the presence of an associated event, such opening of one of the doors, the vehicle trunk, the engine hood, etc., in a conventional manner. The sensors 21 can include infrared sensors, pressure sensors, voice discriminators, radar sensors, etc., depending upon the events to be detected thereby.

The remote controller 2 is operated by the vehicle owner to control operation of the main terminal 1. For example, the remote controller 2 can be operated to arm or disarm the main terminal 1. When the main terminal 1 is armed, it can operate further according to the events detected by the various sensors 21. On the other hand, when the main terminal 1 is disarmed, the events detected by the various sensors 21 will not trigger further operation of the main terminal 1. Moreover, the remote controller 2 can act as a bi-directional interface between the main terminal 1 and the vehicle owner. Particularly, the main terminal 1 can transmit status information to the remote controller 2 to provide relevant information to the vehicle owner pertaining to the current state of the vehicle 20. Since the main feature of the present invention does not reside in the bi-directional communications link between the main terminal 1 and the remote controller 2, a detailed description of the same will be dispensed with herein for the sake of brevity.

As shown in FIG. 1, the main terminal 1 includes a control unit 11, an audio processing unit 12, and a loudspeaker 13.

The control unit 11 includes a control processor 111 connected electrically to the sensors 21, and a wireless transceiver 112 connected electrically to the control processor 111 and adapted to establish a bi-directional wireless communications link between the control processor 111 and the remote controller 2. The control processor 111 is programmed beforehand so that, in response to an event detected by one of the sensors 21, the control processor 111 will generate a corresponding control signal. For example, when a vehicle door is opened, the sensor 21 adjacent to the vehicle door will inform the control processor 111 accordingly, and the control processor 111 will generate the control signal 00000001 that is provided to the audio processing unit 12. Unique control signals are generated by the control processor 111 when other events are detected, such as the opening of the engine hood or the vehicle trunk.

As mentioned beforehand, the wireless transceiver 112 establishes a bi-directional wireless communications link between the control processor 111 and the remote controller 2. Therefore, upon receipt of an arming request from the remote controller 2, the wireless transceiver 112 informs the control processor 111 accordingly so as to arm the main terminal 1. Moreover, when an event is detected by one of the sensors 21, the control processor 111 transmits an appropriate message to the remote controller 2 through the wireless transceiver 112 so as to inform the vehicle owner accordingly.

The audio processing unit 12 includes an audio processor 121 and a data storage unit 122 connected electrically to the audio processor 121. The audio processor 121 is connected electrically to the control processor 111 and receives the control signal generated by the latter. In practice, the transfer of control commands, data and addresses from one of the processors 111, 121 to the other is accomplished through the use of control lines, data lines and address lines in a manner similar to data transmission techniques commonly employed by conventional processors. The audio processor 121 is capable of both analog-to-digital and digital-to-analog signal conversion. This will be described in greater detail in the succeeding paragraphs.

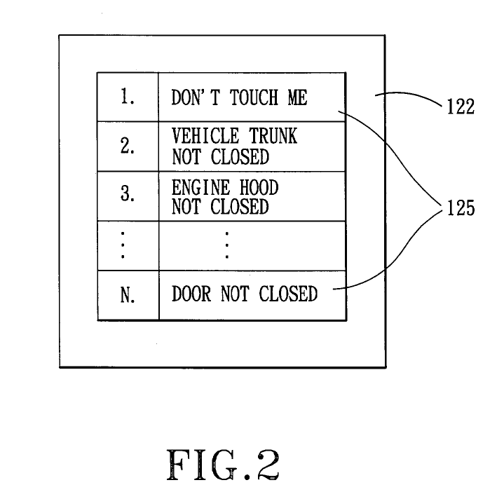

The storage unit 122, such as a read only memory or a flash memory in this embodiment, has a set of alarm sound data 125 stored therein. As shown in FIG. 2, the alarm sound data 125 are unique to each other, and can thus be distinguished from each other when reproduced. In this embodiment, the alarm sound data 125 are speech data, such as “Don't touch me,” “Vehicle trunk not closed,” “Engine hood not closed,” etc., each of which corresponds to one of the control signals generated by the control processor 111.

In use, when the main terminal 1 is armed, and one of the sensors 21 detects the presence of an associated event, such as impact to the vehicle body, unlocking of one of the vehicle doors, etc., the control processor 111 will be informed of the detected event accordingly. Thereafter, in response to the detected event, the control processor 111 generates the corresponding control signal that is provided to the audio processing unit 12. In response to the control signal from the control processor 111, the audio processor 121 retrieves one of the alarm sound data 125 stored in the data storage unit 122 at a location corresponding to the control signal, and converts the same into an analog signal that is to be supplied to the loudspeaker 13. In practice, the loudspeaker 13 may be a built-in loudspeaker of the vehicle 20. The audio processor 121 enables the loudspeaker 13 to continuously reproduce the analog signal within a period of time, thereby generating an audible alarm output that corresponds to the detected event so as to achieve the intended effects of scaring off prospective thieves and vandals and alerting people nearby.

Preferably, the audio processing unit 12 further includes a power amplifier 3 connected electrically to the audio processor 121 and the loudspeaker 13. The amplifier 3 amplifies the analog signal that is to be reproduced by the loudspeaker 13.

For added convenience, the audio processing unit 12 of the audio alarm system of the preferred embodiment further includes a control switch 4 and an input port 5 connected electrically to the audio processor 121. The input port 5 is a sound input port that can be used by the vehicle owner when recording the alarm sound data 125 in the data storage unit 122 through the audio processor 121. The control switch 4 is operated to enable the recording function of the audio processor 121. Particularly, when the control switch 4 is operated, analog voice signals inputted at the input port 5 are converted by the audio processor 121 into the corresponding digital alarm sound data to be recorded in the data storage unit 122. Thus, the control switch 4 and the input port 5 cooperate to form a recording unit for enabling the audio processor 121 to record the alarm sound data in the data storage unit 122.

Therefore, when the vehicle owner leaves the vehicle 20 that incorporates the audio alarm system of this invention, different audible alarm outputs, such as “Vehicle trunk not closed,” “Vehicle door not locked,” etc., can be generated to alert the vehicle owner. Moreover, when the vehicle 20 is the target of vandals or prospective thieves, other audible alarm outputs, such as “Don't touch me,” “The vehicle owner is returning,” etc., can be generated to scare off vandals and prospective thieves. Because the audible alarm outputs are in the form of speech that can be pre-recorded by the vehicle owner, the vehicle owner can easily distinguish whether his vehicle generated an alarm.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An audio alarm system adapted to be installed in a vehicle, the vehicle having a set of sensors disposed thereon, each of the sensors detecting presence of an associated event, said audio alarm system comprising:
a control unit adapted to be connected electrically to the sensors and configured to generate a set of control signals, each of the control signals being generated by said control unit in response to detection of the presence of the associated event by a corresponding one of the sensors;
an audio processing unit having a set of alarm sound data stored therein, the alarm sound data being distinguishable from each other and corresponding respectively to the control signals, said audio processing unit being connected electrically to said control unit and, in response to the control signal received from said control unit, selecting the corresponding one of the alarm sound data; and
a loudspeaker connected electrically to said audio processing unit and operable so as to generate an audible alarm output corresponding to the alarm sound data selected by said audio processing unit.

2. The audio alarm system as claimed in claim 1, wherein said audio processing unit includes an audio processor connected electrically to said control unit, and a data storage unit connected electrically to said audio processor and having said alarm sound data stored therein.

3. The audio alarm system as claimed in claim 2, wherein said audio processor is configured to convert the alarm sound data corresponding to the control signal received from said control unit into an analog signal that is to be supplied to said loudspeaker.

4. The audio alarm system as claimed in claim 3, wherein said audio processing unit further includes an amplifier connected electrically to said audio processor and said loudspeaker, said amplifier amplifying the analog signal that is to be provided by said audio processor to said loudspeaker.

5. The audio alarm system as claimed in claim 2, wherein said audio processing unit further includes a recording unit connected electrically to said audio processor for enabling said audio processor to record the alarm sound data in said data storage unit.

6. The audio alarm system as claimed in claim 1, wherein the alarm sound data are speech data.

7. An audio alarm system for a vehicle having a set of sensors disposed thereon, each of the sensors detecting presence of an associated event, said audio alarm system comprising:
a main terminal adapted to be installed in the vehicle, said main terminal generating an audible alarm output in response to detection of the presence of the event associated with any one of the sensors when said main terminal is armed, said main terminal including
a control unit adapted to be connected electrically to the sensors and configured to generate a set of control signals, each of the control signals being generated by said control unit in response to detection of the presence of the associated event by a corresponding one of the sensors,
an audio processing unit having a set of alarm sound data stored therein, the alarm sound data being distinguishable from each other and corresponding respectively to the control signals, said audio processing unit being connected electrically to said control unit and, in response to the control signal received from said control unit, selecting the corresponding one of the alarm sound data, and
a loudspeaker connected electrically to said audio processing unit and operable so as to generate the audible alarm output that corresponds to the alarm sound data selected by said audio processing unit; and
a remote controller operably associated with said main terminal to control arming and disarming of said main terminal.

8. The audio alarm system as claimed in claim 7, wherein said control unit includes a control processor connected electrically to said audio processing unit and adapted to be connected electrically to the sensors, and a wireless transceiver connected electrically to said control processor and operable so as to establish a wireless communications link between said control processor and said remote controller so that arming and disarming of said main terminal can be controlled through said remote controller.

9. The audio alarm system as claimed in claim 7, wherein said audio processing unit includes an audio processor connected electrically to said control unit, and a data storage unit connected electrically to said audio processor and having said alarm sound data stored therein.

10. The audio alarm system as claimed in claim 9, wherein said audio processor is configured to convert the alarm sound data corresponding to the control signal received from said control unit into an analog signal that is to be supplied to said loudspeaker.

11. The audio alarm system as claimed in claim 10, wherein said audio processing unit further includes an amplifier connected electrically to said audio processor and said loudspeaker, said amplifier amplifying the analog signal that is to be provided by said audio processor to said loudspeaker.

12. The audio alarm system as claimed in claim 9, wherein said audio processing unit further includes a recording unit connected electrically to said audio processor for enabling said audio processor to record the alarm sound data in said data storage unit.

13. The audio alarm system as claimed in claim 7, wherein the alarm sound data are speech data.
